(19) United States
(12) Patent Application Publication
(10) Pub. No.: US 2001/0036769 A1
(43) Pub. Date: Nov. 1, 2001

(54) Method for mounting a connector on a printed circuit board, and shielded connector and lower shielding plate for use in sush a method

(76) Inventors: Nadia Otto, Mechelen (BE); Marc Fret, Hoboken (BE); Hubert Booghmans, Meise-Wolvertem (BE); Werner Panis, Tessenderlo (BE)

Correspondence Address: PERMAN & GREEN, 425 POST ROAD, FAIRFIELD, CT, 06430, US

(21) Appl. No.: 09/808,283

(22) Filed: Mar. 14, 2001

(30) Foreign Application Priority Data
Mar. 15, 2000 (NL) NL 1014646

(51) Int. Cl. H01R 13/648

(52) U.S. Cl. 439/607

(57) ABSTRACT

A shielded connector comprises a housing of insulating material accommodating a plurality of contact elements, and a shielding plate comprising a front half and a back half. The front half has a plurality of contact portions and the back half has contact ends for connection to a printed circuit board. The housing is provided with at least one channel at a front end thereof, this at least one channel being open at its back end and closed at its front end for receiving the front end of the shielding plate. The shielding plate is provided with a bend near its front end for cooperation with back end of the channel. The connector is mounted on a printed circuit board and then the shielding plate is mounted on the printed circuit board by first inserting the front end of the lower shielding plate into the at least one channel until the contact ends are at least substantially aligned with the through holes of the printed circuit board and thereafter inserting the contact ends into the through holes of the printed circuit board.

The invention relates to a method for mounting a connector on a printed circuit board according to the preamble of claim 1, to a shielded connector with lower shielding plate according to the preamble of claim 5, to a shielded connector according to the preamble of claim 8, and to a lower shielding plate according to the preamble of claim 11.

A method of this type is disclosed in U.S. Pat. No. 5,259,773. In this known method the lower shielding plate is mounted on the lower side of the printed circuit board by moving the complete plate mainly perpendicular to the lower side of the a printed circuit board. During this movement the contact ends are inserted into through holes of the printed circuit board, while an end edge of the plate engages the front end edge of the printed circuit board. This requires an accurate manufacturing of the lower shielding plate as the distance between the end edge and the contact ends should be the same as the distance between the front end of the printed circuit board and the through holes. Moreover, the front end of the connector housing is not covered by the lower shielding plate.

The invention aims to provide an improved method of the above-mentioned type and a shielded connector and lower shielding plate for use in such a method.

To this end the method of the invention is characterized by the characterizing features of claim 1.

In this manner the front end of the lower shielding plate can be received with play in the at least one channel at the front end of the housing, wherein any tolerances can be absorbed by the channel. Moreover, also the front end of the housing is mainly covered by the lower shielding plate.

In a preferred embodiment the shielding plate is provided with a bend near its front end, wherein the front end of the shielding plate is inserted into said at least one channel until the bend meets the back end of the channel, wherein the bend is located such that the contact ends will be aligned with the through holes of the printed circuit board when the bend is located at the back end of the channel. In this manner the mounting of the lower shielding plate is simplified.

In a further preferred embodiment the shielding plate is provided with an inclined intermediate part between a front half and a back half of the shielding plate, wherein the back half is pressed towards the printed circuit board during inserting the contact ends into the through holes, wherein by the inserting step the inclined part is at least partially flattened to thereby push the front end of the shielding plate further into said at least one channel and to bring the contact portions in position. In this manner mounting of the lower shielding plate is relatively simple, wherein by inserting the contact ends into the through holes the front end is automatically pushed further into the at least one channel of the housing.

The shielded connector and lower shielding plate of the invention are characterized in that the housing is provided with at least one channel at a front end thereof, said at least one channel being open at its back end and closed at its front end for receiving the front end of a shielding plate, and in that the shielding plate is provided with a bend near its front end for co-operation with a housing part of a connector.

The invention will be further explained by reference to the drawings in which an embodiment of the shielded connector and shielding plate of the invention are schematically shown and moreover some steps of the method of the invention are shown for explanation.

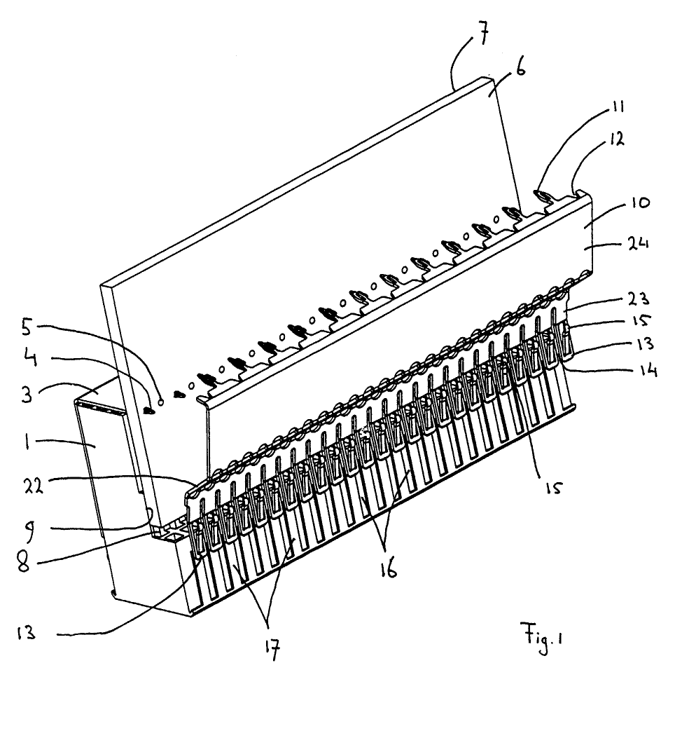

FIG. 1 is a perspective view of an embodiment of the shielded connector of the invention as mounted on a printed circuit board together with an embodiment of the shielding plate before mounting the same.

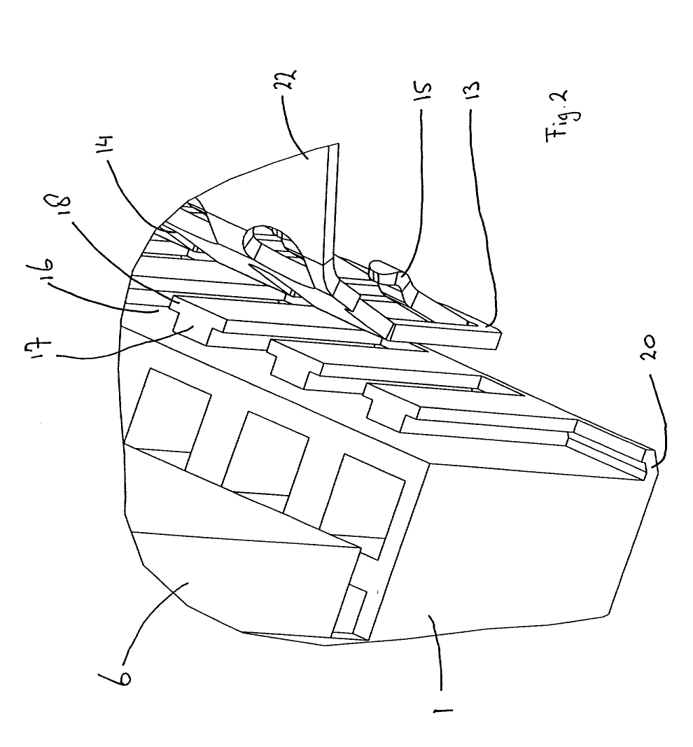

FIG. 2 shows a detail of the connector and shielding plate of FIG. 1 at a larger scale.

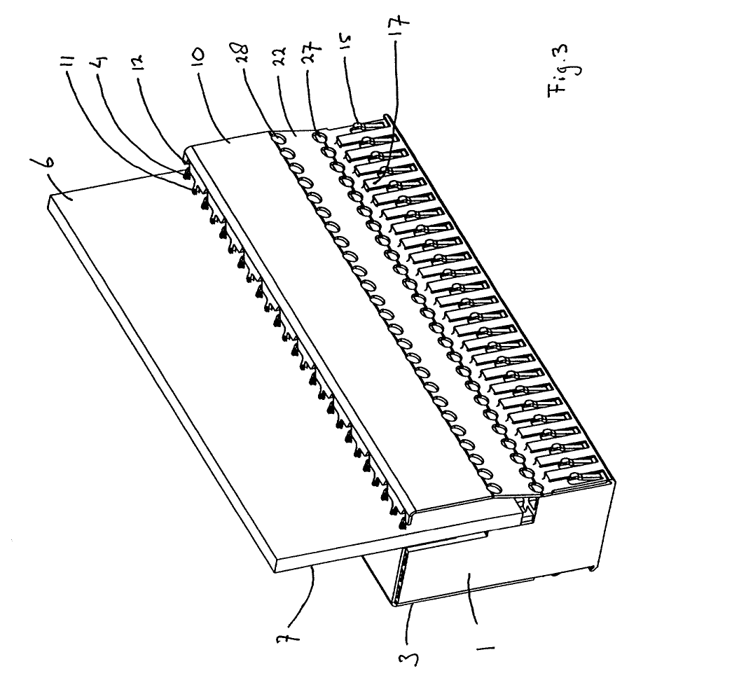

FIG. 3 is a perspective view of the connector and shielding plate of FIG. I after mounting the shielding plate.

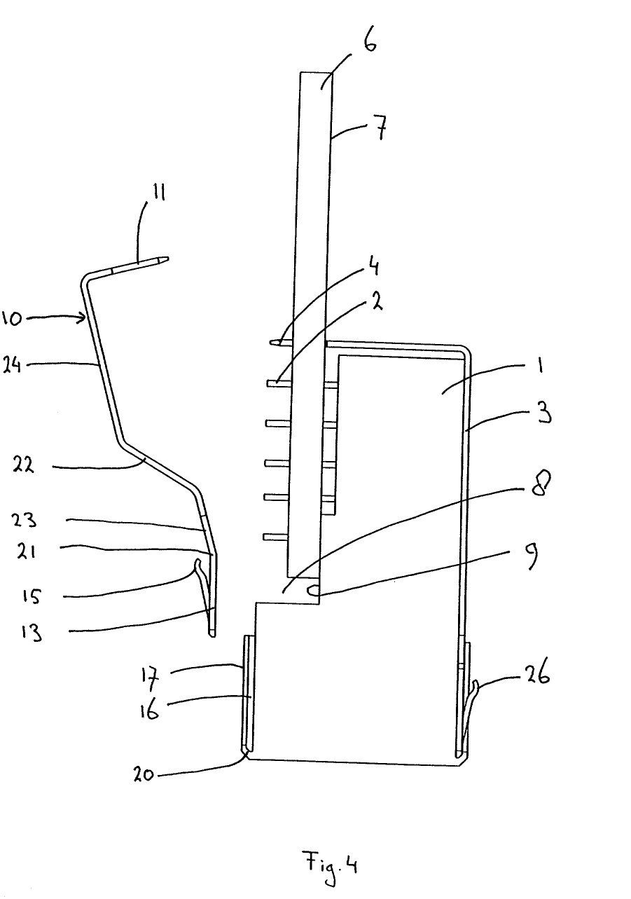

FIGS. 4-7 show four steps of an embodiment of the method of the invention.

FIG. 1 shows a perspective view of a shielded connector comprising a housing 1 of insulating material accommodating a plurality of contact elements 2, of which only the contact ends projecting out of the housing can be seen in FIGS. 4-7. The connector further comprises an upper shielding plate 3 covering an upper side and a backside of the housing. The upper shielding plate 3 is provided with a plurality of contact ends 4 inserted in through holes 5 of a printed circuit board 6 just as the contact ends of the contact elements 2 (not shown in FIG. 1). The shielded connector is mounted on the printed circuit board 6 by inserting the contact ends of the contact elements 2 and the contact ends 4 of the upper shielding plate 3 into the through holes 5 in a usual manner. The upper side 7 of the printed circuit board 6 is received in a recess 8 of the housing 1 against a lower side 9 of the housing.

FIG. 1 further shows a lower shielding plate 10 having contact ends 11 at a back end, which contact ends 11 are an integral part of the lower shielding plate 10. As will be explained hereinafter, the contact ends 11 are inserted into through holes 5 of the same row of through holes as the contact ends 4 of the upper shielding plate 3, wherein recesses 12 are provided between the contact ends 11 for receiving the contact ends 4 projecting through the through holes 5.

As clearly shown in FIG. 1, the lower shielding plate 10 is provided with a plurality of shielding fingers 13 at its front end, the shielding fingers 13 being separated by slots 14. Each shielding finger 13 is provided with a contact spring 15 projecting outwardly with respect to the shielding fingers 13. These contact springs 15 operate as contact portions near the front end of the shielding plate 10.

The lower side 9 of the housing 1 is provided with a plurality of channels 16 at its front end to receive the shielding fingers 13. The channels 16 are separated by ribs 17 having a T-shaped cross section as can be seen in particular in FIG. 2. In this manner, the T-shaped ribs 17 provide head parts 18 engaging side edges of the shielding fingers 13. Slots 19 between the head parts 18 of the T-shaped ribs 17 receive the contact springs 15 (FIG. 4) so that these contact springs 15 can co-operate with corresponding contact portions of a complementary connector.

The channels 16 are closed at their front ends by a front wall 20 having an L-shaped cross section, the free end of which engages around the corresponding shielding finger 13. The channels 16 are open at their back end to allow insertion of the shielding fingers 13.

As can be seen in the drawings, in particular in FIGS. 2, 4 and 5, the lower shielding plate 10 is provided with a bend 21 near its front end, the function of which will be discussed hereinafter. Further, the lower shielding plate 10 comprises an inclined intermediate part 22 between a front half 23 and a back half 24 of the plate 10.

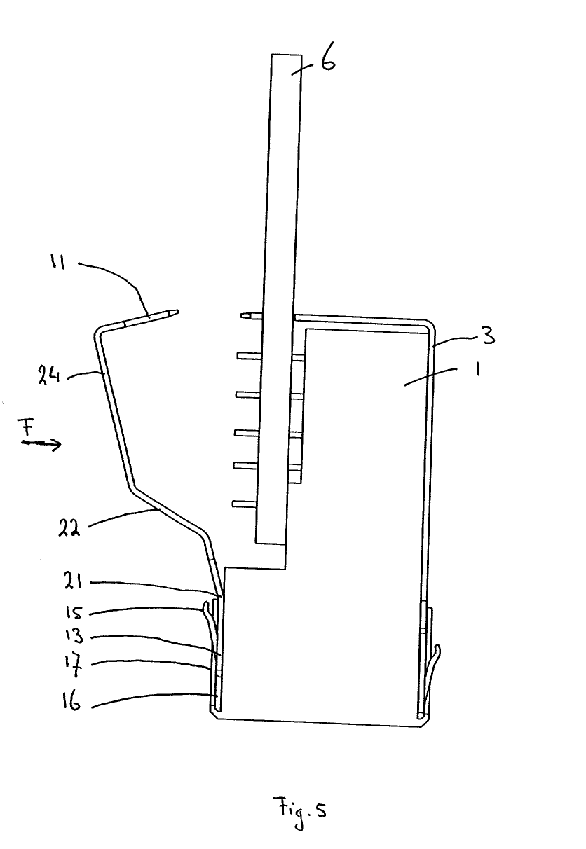

For mounting the lower shielding plate 10, the shielding fingers 13 are inserted into the channels 16 until the bend 21 meets the back ends of the channels 16, i.e. the back ends of the ribs 17. The bend 21 is located such that when the bend 21 meets the back ends of the ribs 17, the contact ends 11 of the lower shielding plate are aligned with the through holes 5. The first steps of the method for mounting the lower shielding plate 10 are shown in FIGS. 4 and 5, wherein FIG. 5 shows the lower shielding plate 10 with the bend 21 contacting the back ends of the ribs 17. By exerting a force as indicated by an arrow F, the lower shielding plate 10 is rotated towards the printed circuit board 6, wherein the contact ends 11 are introduced into the through holes 5.

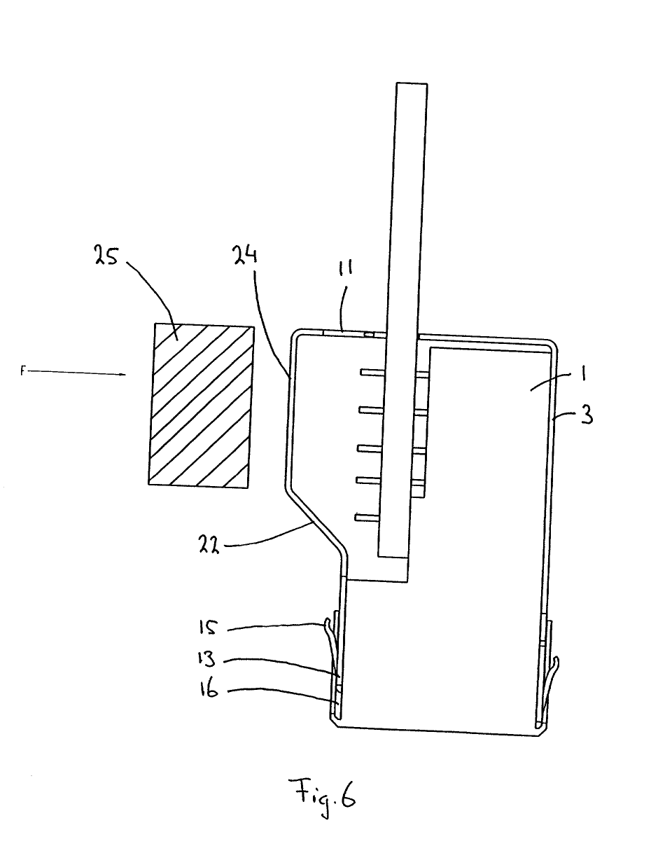

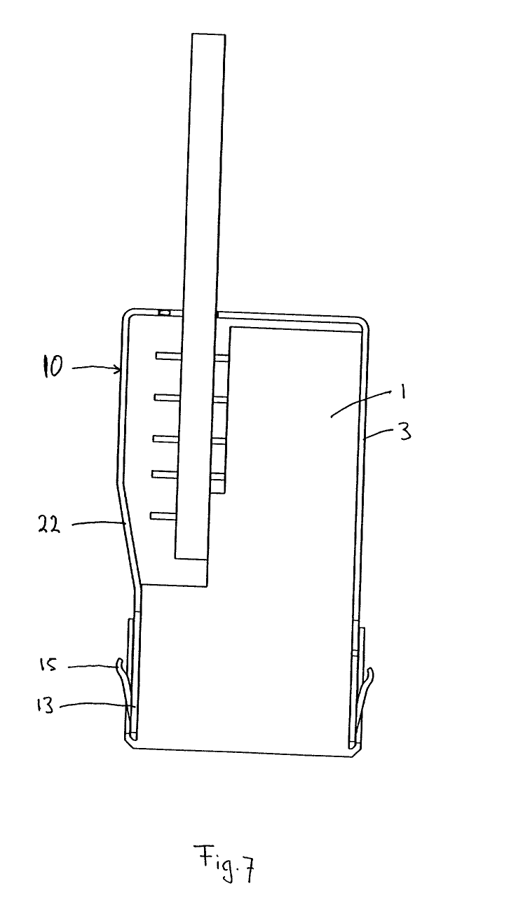

By means of a schematically indicated single tool 25 (FIG. 6), a force is exerted on the back half 24 of the lower shielding plate thereby inserting the contact ends 11 further into the through holes 5 and flattening the intermediate part 22, so that the shielding fingers 13 are further slid into the channels 16. The end position of the lower shielding plate 10 with the shielding fingers 13 fully introduced into the channels 16 is shown in FIG. 7, in which end position the contact springs 15 of the lower shielding plate 10 are substantially at the same height as contact springs 26 of the upper shielding plate 3.

The method described for mounting the shielded connector together with the lower shielding plate 10 shows the advantage that any tolerances can be absorbed in the channels 16 of the housing 1. Positioning the contact ends 11 in alignment with the through holes 5 is relatively simple by providing the bend 21 in the lower shielding plate 10. The tooling for mounting the lower shielding plate 10 is relatively simple as a single tool 25 can be used for inserting the contact ends 11 into the through holes 5 and by the same operation for further inserting the shielding fingers 13 into the channels 16.

It is noted that to prevent damage to the housing 1 during flattening the intermediate part 22, holes 27, 28 are provided at the transitions of the intermediate part 22 and the front half 23 and back half 24, respectively. By weakening the transitions in this manner it is guaranteed that the lower shielding plate will be deformed at these transitions. As the contact springs 15 are carried by independent shielding fingers 13, a favourable spring operation of the contact springs 15 is guaranteed. However, it is not strictly necessary to provide an independent shielding finger for each contact spring 15. To apply the invention, the front end of the housing 1 should have at least one channel for receiving the front end with contact springs 15 of the lower shielding plate 10. Further, the mounting of the lower shielding plate 10 by first inserting the front end into the channels from the back side and thereafter inserting the contact ends is also possible with a shielding plate without inclined intermediate part. An embodiment with inclined intermediate part is however preferred.

The invention is not restricted to the above-described embodiment which can be varied in a number of ways within the scope of the following claims.

1. Method for mounting a connector on a printed circuit board, comprising providing a connector having a housing of insulating material with a plurality of contact elements, providing a printed circuit board having a plurality of through holes, mounting the connector on the printed circuit board, providing a shielding plate having contact ends at a back end and contact portions near a front end, and mounting the shielding plate on the printed circuit board by inserting the contact ends into through holes of the printed circuit board, characterized in that a housing is provided having at least one channel at a front end thereof, said channel being closed at its front end and open at its back end, and in that the shielding plate is mounted on the printed circuit board by first inserting its front end into said at least one channel until the contact ends are at least substantially aligned with the through holes of the printed circuit board and thereafter inserting the contact ends into the through holes of the printed circuit board.

2. Method according to claim 1, wherein the shielding plate is provided with a bend near its front end, wherein the front end of the shielding plate is inserted into said at least one channel until the bend meets the back end of the channel, wherein the bend is located such that the contact ends will be aligned with the through holes of the printed circuit board when the bend is located at the back end of the channel.

3. Method according to claim 1 or 2, wherein the shielding plate is provided with an inclined intermediate part between a front half and a back half of the shielding plate, wherein the back half is pressed towards the printed circuit board during inserting the contact ends into the through holes, wherein by the inserting step the inclined part is at least partially flattened to thereby push the front end of the shielding plate further into said at least one channel and to bring the contact portions in position.

4. Method according to any one of the preceding claims, wherein the housing at its front end is provided with a series of adjacent channels separated by ribs with a T-shaped cross section, wherein the front end of the shielding plate is provided with a series of fingers separated by slots, each finger having a contact spring, wherein during the step of mounting the shielding plate the fingers are inserted into the channels, wherein side edges of the fingers are received below the heads of the T-shaped ribs and the contact springs are received in slots between the heads of the T-shaped ribs.

5. Shielded connector and shielding plate, the connector comprising a housing of insulating material accommodating a plurality of contact elements, and the shielding plate comprising a front half and a back half, the front half having a plurality of contact portions and the back half having contact ends for connection to a printed circuit board, characterized in that the housing is provided with at least one channel at a front end thereof, said at least one channel being open at its back end and closed at its front end for receiving the front end of the shielding plate, and in that the shielding plate is provided with a bend near its front end for cooperation with a back end of the channel.

6. Shielded connector and shielding plate according to claim 5, wherein the front end of the housing is provided with a series of adjacent channels separated by ribs with a T-shaped cross section, wherein the front end of the shielding plate is provided with a series of fingers separated by slots, each finger having a contact spring, wherein the fingers are adapted to be received in the channels, wherein the heads of the T-shaped ribs are adapted to engage side edges of the fingers, wherein the width of the contact springs is less than the width of the slots between the heads of the T-shaped ribs.

7. Shielded connector, comprising a housing of insulating material accommodating a plurality of contact elements, characterized in that the housing is provided with at least one channel at a front end thereof, said at least one channel being open at its back end and closed at its front end for receiving the front end of a shielding plate.

8. Shielded connector according to claim 7, wherein said at least one channel is provided with a front wall with L-shaped cross section adapted to engage the front end of a shielding plate.

9. Shielded connector according to claim 7 or 8, wherein the front end of the housing is provided with a series of adjacent channels separated by ribs with a T-shaped cross section.

10. Shielding plate comprising a front half and a back half, the front half having a plurality of contact portions and the back half having contact ends for connection to a printed circuit board, characterized in that the shielding plate is provided with a bend near its front end for co-operation with a housing part of a connector.

11. Shielding plate according to claim 10, wherein the front end of the shielding plate is provided with a series of fingers separated by slots, each finger having a contact spring projecting outwardly with respect to the fingers.

12. Shielding plate according to claim 10 or 11, wherein an inclined intermediate section is provided between the front and back halves.

13. Shielding plate according to claim 10, 11 or 12, wherein the transitions between the intermediate part and the front and back halves are weakened.
